(19) United States
(12) Patent Application Publication
(10) Pub. No.: US 2009/0100205 A1
(43) Pub. Date: Apr. 16, 2009

(54) MANAGMENT SYSTEM FOR RE-DISPLAYING CHARACTERS ON TERMINAL AND METHOD THEREOF

(75) Inventors: Wen Zhang, Shijr City (TW); Ming-Jian Liu, Shijr City (TW)

Correspondence Address: AUSTIN RAPP & HARDMAN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/871,038

(22) Filed: Oct. 11, 2007

(51) Int. Cl. G06F 3/14

(52) U.S. Cl. 710/100

(57) ABSTRACT

A management system for re-displaying characters on the terminal and re-displaying method thereof are disclosed. The management system includes a buffer having first buffer and a second buffer, a first switch, a second switch, and a control unit. The first buffer stores a plurality of characters constituting an image shown on a display of the terminal if the terminal is switched from the first computing device to the second computing device or if the second switch selects one of a first buffer set and a second buffer set. The second buffer stores a plurality of attributes constituting the image shown on the display of the terminal if the terminal is switched from the first computing device to the second computing device, or if the second switch selects one of a first buffer set and a second buffer set. The first switch couples one of the first computing device and the second computing device to the first buffer and the second buffer. The control unit is capable of controlling the switching procedure between the first computing device and the second computing device.

### FIELD OF THE INVENTION

The present invention relates to a management system, and more particularly to a management system for re-displaying a plurality of characters and attributes of the characters from a computing device on a terminal and re-displaying method thereof.

### BACKGROUND OF THE INVENTION

Telnet connection is a bi-directional character-oriented communication application primarily designed to provide a virtual terminal (VT) process via a network. The communication application allows a client computer and a server computer on the network to communicate one another. Therefore, a user on a terminal connected to client computer could communicate with the server computer as if the terminal of the client computer is directly connected to the server computer. Once the telnet connection between the terminal and the server computer is established, user's inputs from the terminal must be transferred to the server computer and the outputs from the server computer should be transferred back to the terminal. However, in order to show the outputs from the server computer on the terminal, the display format of the outputs should be transformed from one kind of format to another in advance. Otherwise, when the outputs are transferred to the terminal, the display format outputs shown on the terminal will be in a state of chaos. Particularly, when the terminal is switched between the server computers, the outputs generated from the server computers cannot be correctly shown on the terminal. Consequently, it is necessary to develop a novel management system to solve the above-mentioned problem.

### SUMMERY OF THE INVENTION

One objective of the present invention is to provide a management system and method for re-displaying the characters if the terminal is switched from a first computing device to a second computing device, or if the switch selects one of the first buffer set and the second buffer set.

Another objective of the present invention is to provide a management system and method for efficiently recording and re-displaying the characters previously inputted on the computing devices.

According to the objectives, the management system is capable of coupling a first terminal to one of a first computing device and a second computing device. In the first embodiment, the management system includes a buffer having first buffer and a second buffer, a first switch, a second switch, and a control unit. The first buffer stores a plurality of characters constituting an image shown on a display of the terminal if the terminal is switched from the first computing device to the second computing device. The second buffer stores a plurality of attributes constituting the image shown on the display of the terminal if the terminal is switched from the first computing device to the second computing device. Alternatively, it should be noted that the characters and the attributes may be stored in single buffer. The first switch couples one of the first computing device and the second computing device to the first buffer and the second buffer. The control unit is capable of controlling the switching procedure between the first computing device and the second computing device.

In the second embodiment, the management system includes a first buffer set having a first buffer and a second buffer, a second buffer set having third buffer and a fourth buffer, a second switch, and a control unit. At first, it assumes that the first terminal is coupled to the first computing device. The first buffer set stores a plurality of characters and a plurality of attributes which are transmitted by the first computing device and constitute an image shown on a display of the first terminal, wherein the characters and the attributes are saved in the first buffer and the second buffer 116b, respectively. The second buffer set stores a plurality of characters and a plurality of attributes which are transmitted by the second computing device and constitute the image shown on the display of the first terminal, wherein the characters and the attributes are saved in the third buffer and the fourth buffer, respectively. Alternatively, a larger buffer is used to store both the characters and the attributes constituting the image. The control unit is capable of controlling the switching procedure between the first buffer set and the second buffer set.

For example, the terminal establishes a telnet connection to login to the first computing device and the second computing device via the management system as if the terminal is directly connected to the first computing device and the second computing device. The attributes further include background color, foreground color, highlight, underline, blink, inverse video, single-width-single-height, double-width-double-height (top half), double-width-double-height (bottom half), and double-width-single-height of the characters shown on the display. In addition, since the first computing device stores the characters and the attributes in the first buffer and the second buffer in parallel, the first terminal can rapidly access the characters and the attributes.

The management system performs the recording and re-displaying functions while switching the first computing device and the second computing device therebetween. The user operates the first terminal, and the first terminal switches between the first computing device and the second device so that the operated terminal can access the switched computing device. When the operated terminal, i.e. the first terminal, switches from the second computing device back to the first computing device, i.e. from a currently connected port to a previously connected port, the operated terminal is capable of obtaining entire operation image without image loss by recording all the characters and related attributes in the buffer. Then, the operated terminal re-displays the image such that the user can continuously operate the first computing device based on the image transmitted from the first computing device. In other words, the image shown on the terminal is changed to allow the user continuously to operate the switched computing device based on the image shown on the terminal when the computing devices are switched.

In operation, the management system is coupled to one of the first computing device and the second computing device. Then, the control unit controls the first buffer and the second buffer for recording a plurality of characters and a plurality of attributes constituting the image from the first computing device if the terminal is switched from the first computing device to the second computing device, or if the switch selects one of the first buffer set and the second buffer set. Finally, the control unit controls the first buffer and the second buffer for re-displaying the image on a display of the terminal based on the characters and the attributes if the terminal is switched from the second computing device to the first computing device again, or if the switch selects one of the first buffer set and the second buffer set.

### BRIEF DESCRIPTION OF THE DRAWINGS

The foregoing aspects and many of the attendant advantages of this invention will become more readily appreciated as the same becomes better understood by a reference to the following detailed description, when taken in conjunction with the accompanying drawings, wherein:

FIG. 1A is a management system according to a first embodiment of the present invention;

FIG. 1B is a management system according to a second embodiment of the present invention;

FIG. 2A is an image shown on the terminal and including characters and attributes while the terminal logins to the first computing device via the management system shown in FIGS. 1A and 1B according to one embodiment of the present invention;

FIG. 2B is the image having input command based on FIG. 2A after the terminal logins to the first computing device via the management system shown in FIGS. 1A and 1B according to one embodiment of the present invention;

FIG. 2C is an image shown on the terminal and including characters and attributes while the terminal switches from the first computing device to the second computing device to login to the second computing device via the management system shown in FIGS. 1A and 1B according to one embodiment of the present invention;

FIG. 2D is the image shown in FIG. 2B and having the command after the terminal switches from the second computing device back to the first computing device according to one embodiment of the present invention; and

FIG. 3 is a flow chart of performing the management system shown in FIGS. 1A and 1B according to one embodiment of the present invention.

### DETAILED DESCRIPTION OF THE INVENTION

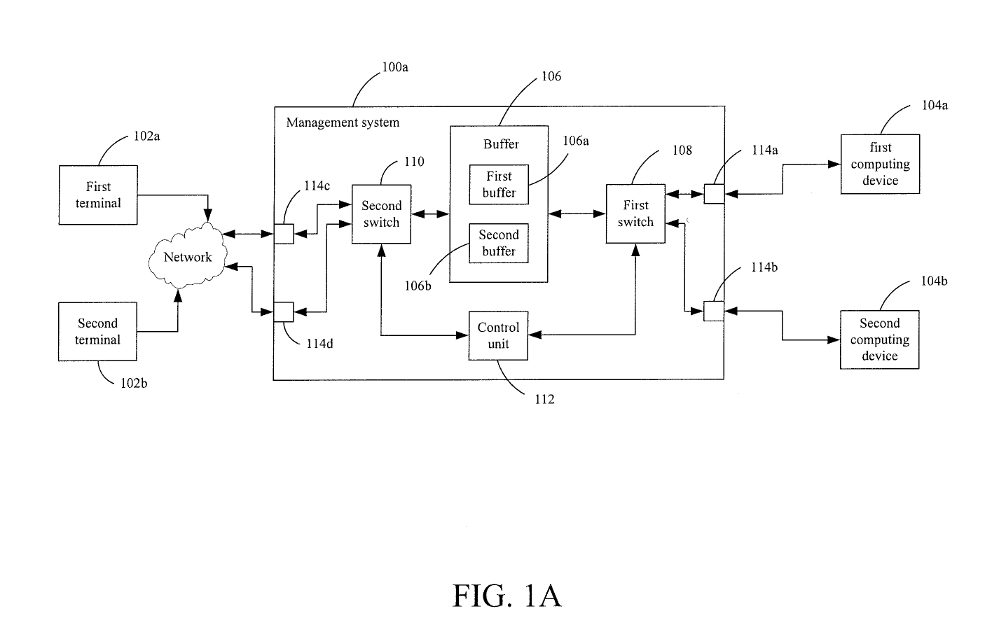

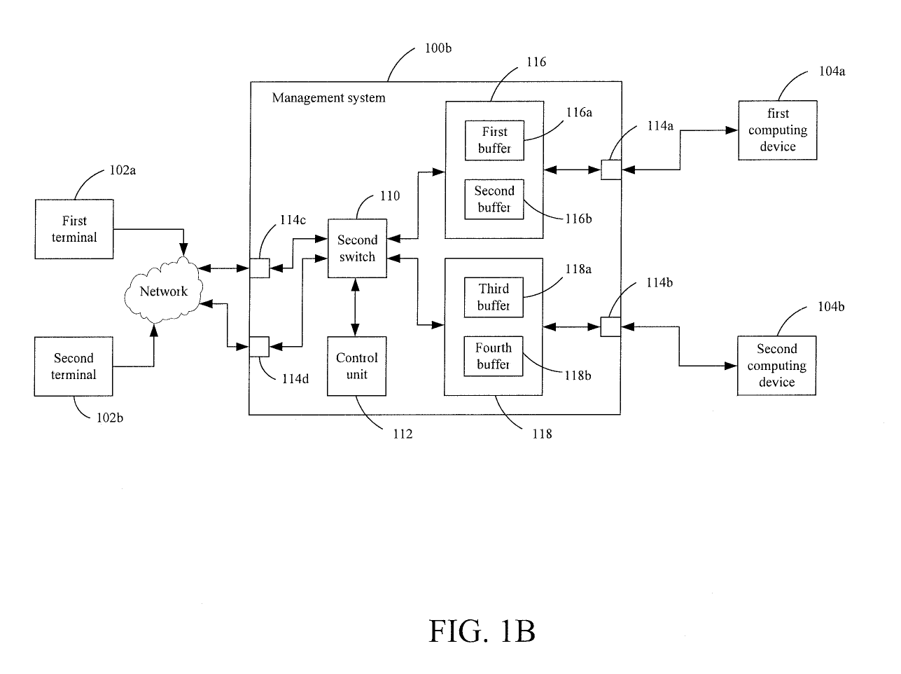

Please refer to FIG. 1A which depicts a management system according to a first embodiment of the present invention. The management system 100a is a control unit that provides both In-Band and Out-of-Band remote access to up to or 16 servers or other serial IT devices (hubs, routers, power management device, etc.), via a Telnet or SSH TCP/IP connection. Users can log in at the same time from any computer connected to the Internet, whether down the hall, or half way around the world. Each user is able to control a separate port so that attached devices can be accessed at the same time. The management system 100a can be SN0108 or SN0116 with updated firmware, manufactured by ATEN International Co., Ltd.

The management system 100a is capable of coupling a first terminal 102a and a second terminal 102b to one of a first computing device 104a and a second computing device 104b. The management system 100a includes a buffer set 106 having a first buffer 106a and a second buffer 106b, a first switch 108, a second switch 110, and a control unit 112. The first buffer 106a and the second buffer 106b of the buffer set 106 are coupled to the first switch 108 and the second switch 110, respectively. The first buffer 106a and the second buffer 106b may be two logical or physical storage regions in the buffer 106. Alternatively, it should be noted that the characters and the attributes may be stored in single buffer. The control unit 112 is coupled to the first switch 108 and the second switch 110, respectively.

The first switch 108 couples the first buffer 106a and the second buffer 106b of the buffer set 106 to one of the first computing device 104a and the second computing device 104b via a first port 114a and a second port 114b, respectively. The second switch 110 couples the first buffer 106a and the second buffer 106b of the buffer set 106 to one of the first terminal 102a and the second terminal 102b via a third port 114c and a fourth port 114d, respectively. In one embodiment, the third port 114c and a fourth port 114d are connected to the first terminal 102a and the second terminal 102b via a network. In one embodiment, the second switch 110 may be omitted if one terminal is coupled to a plurality of computing devices for switching therebetween via the management system 100a. The first port 114a and a second port 114b can be the port complying with the Universal Asynchronous Receiver/Transmitter (UART) standard.

At first, it assumes that the first terminal 102a is coupled to the first computing device 104a. The first buffer 106a stores a plurality of characters constituting an image shown on a display of the first terminal 102a if the first terminal 102a is switched from the first computing device 104a to the second computing device 104b. The second buffer 106b stores a plurality of attributes constituting the image shown on the display of the first terminal 102a if the first terminal 102a is switched from the first computing device 104a to the second computing device 104b. Alternatively, a larger buffer is used to store both the characters and the attributes constituting the image. The first switch 108 couples one of the first computing device 104a and the second computing device 104b to the first buffer 106a and the second buffer 106b. The control unit 112 is capable of controlling the switching procedure between the first computing device 104a and the second computing device 104b.

In one embodiment, the first terminal 102a establishes a telnet connection to login to the first computing device 104a and the second computing device 104b via the management system 100a as if the first terminal 102a is directly connected to the first computing device 104a and the second computing device 104b. The attributes further include background color, foreground color, highlight, underline, blink, inverse video, single-width-single-height, double-width-double-height (top half), double-width-double-height (bottom half), and double-width-single-height of the characters shown on the display. Since the characters and the attributes transmitted by the first computing device 104a are saved in the first buffer 106a and the second buffer 106b, respectively, the characters and the attributes can thus be rapidly retrieved and re-displayed on the first terminal 102a if the user performs the switch operation from other port back to the port 114a corresponding to the first computing device 104a.

Please refer to FIG. 1B which depicts a management system 100b according to a second embodiment of the present invention. The management system 100a can be SN0108 or SN0116 with updated firmware, manufactured by ATEN International Co., Ltd. The management system 100b is capable of coupling a first terminal 102a and a second terminal 102b to one of a first computing device 104a and a second computing device 104b. The management system 100b includes a first buffer set 116 having a first buffer 116a and a second buffer 116b, a second buffer set 118 having third buffer 118a and a fourth buffer 118b, a second switch 110, and a control unit 112. The first buffer 116a and the second buffer 116b of the buffer set 116 are coupled to the first computing device 104a, and the third buffer 118a and the fourth buffer 118b of the second buffer set 118 are coupled to the second computing device 104b. The first buffer 116a, the second buffer 116b, the third buffer 118a and the fourth buffer 118b may be four logical or physical storage regions in the buffer set 116. Alternatively, it should be noted that the characters and the attributes may be stored in single buffer. The control unit 112 is coupled to the first switch 108.

The second switch 110 couples the first buffer set 116 and the second buffer set 118 to one of the first terminal 102a and the second terminal 102b via a third port 114c and a fourth port 114d, respectively. In one embodiment, the third port 114c and a fourth port 114d are connected to the first terminal 102a and the second terminal 102b via a network. In one embodiment, the second switch 110 may be omitted if one terminal is coupled to a plurality of computing devices for switching therebetween via the management system 100b. The third port 114c and a fourth port 114d can be the port complying with the Universal Asynchronous Receiver/Transmitter (UART) standard.

At first, it assumes that the first terminal 102a is coupled to the first computing device 104a. The first buffer set 116 stores a plurality of characters and a plurality of attributes which are transmitted by the first computing device 104a and constitute an image shown on a display of the first terminal 102a, wherein the characters and the attributes are saved in the first buffer 116a and the second buffer 116b, respectively. The second buffer set stores a plurality of characters and a plurality of attributes which are transmitted by the second computing device 104b and constitute the image shown on the display of the first terminal 102a, wherein the characters and the attributes are saved in the third buffer 118a and the fourth buffer 118b, respectively. Alternatively, a larger buffer is used to store both the characters and the attributes constituting the image. The control unit 112 is capable of controlling the switching procedure between the first buffer set 116 and the second buffer set 118.

In one embodiment, the first terminal 102a establishes a telnet connection to login to the first computing device 104a and the second computing device 104b via the management system 100b as if the first terminal 102a is directly connected to the first computing device 104a and the second computing device 104b. The attributes further include background color, foreground color, highlight, underline, blink, inverse video, single-width-single-height, double-width-double-height (top half), double-width-double-height (bottom half), and double-width-single-height of the characters shown on the display. Since the characters and the attributes transmitted by the first computing device 104a are saved in the first buffer 106a and the second buffer 106b, respectively, the characters and the attributes can thus be rapidly retrieved and re-displayed on the first terminal 102a if the user performs the switch operation from other port back to the port 114a corresponding to the first computing device 104a.

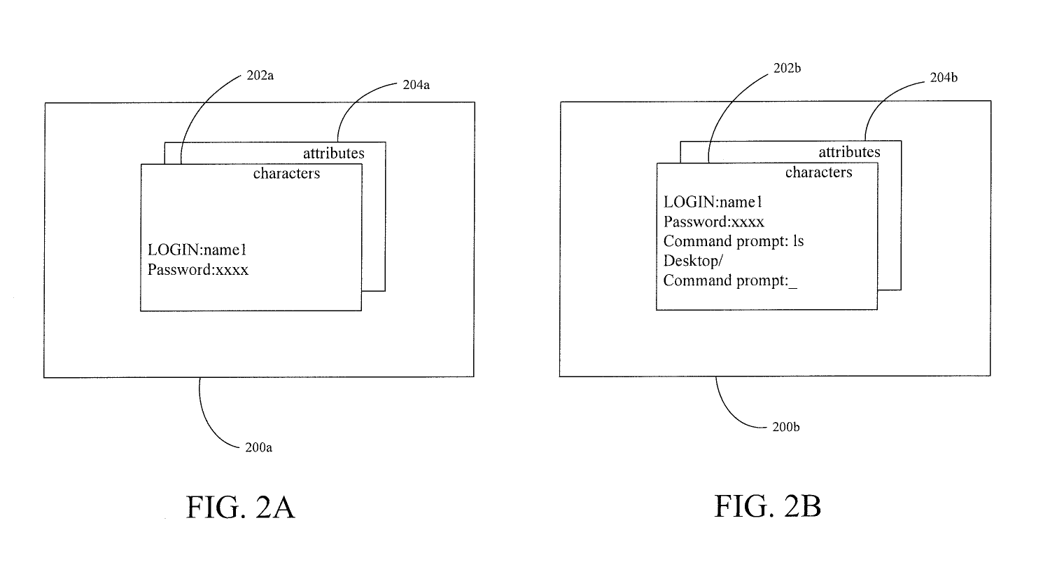

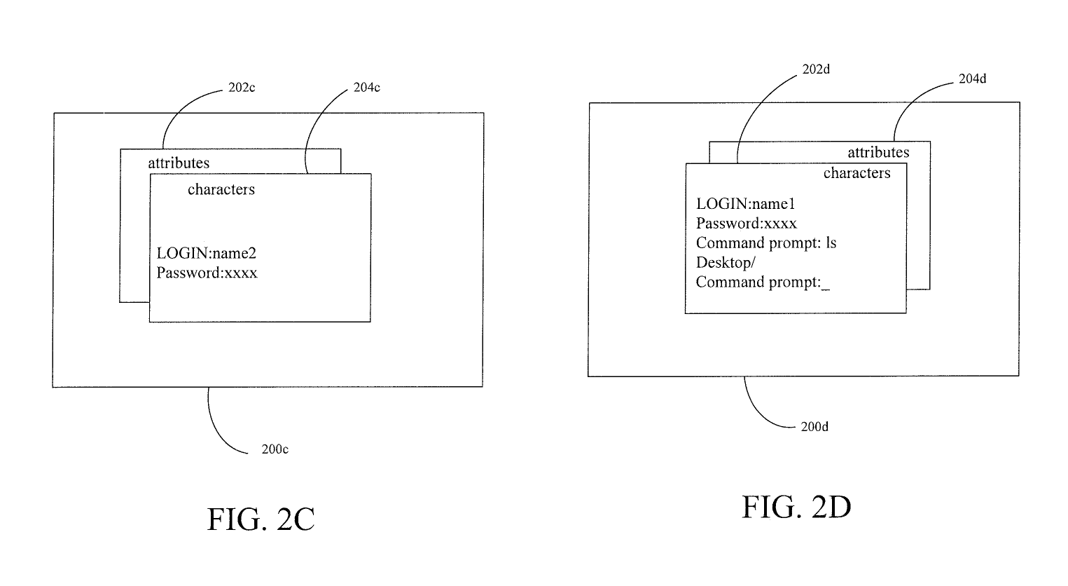

Please refer to FIG. 1A, FIG. 1B and FIG. 2A which depicts the image 200a including characters 202a and attributes 204a while the first terminal 102a logins to the first computing device 104a via the management system 100a, 100b shown in FIGS. 1A and 1B according to one embodiment of the present invention. The image 200a is composed of characters 202a and attributes 204a, and “login:” input prompt and “password:” input prompt are listed within the characters 202a. “Name1” and “xxxx” are then keyed in following the login prompt and password prompt, respectively, and the first terminal 102a can access the first computing device 104a based on the authorization right. During the above operation, the characters 202a and the attributes 204a of the image 200a are saved in the buffer set 106 if the terminal 102a is switched from the first computing device 104a to the second computing device 104b, or if the second switch 110 shown in the FIG. 1B selects one of the first buffer set 116 and the second buffer set 118. Preferably, the characters 202a are recorded in the first buffer 106a and the attributes 204a are stored in the second buffer 106b.

Please refer to FIG. 1A, FIG. 1B and FIG. 2B which depicts the image 200b having input command based on the image 200a shown in FIG. 2A after the first terminal 102a logins to the first computing device 104a via the management system 100a, 100b shown in FIGS. 1A and 1B according to one embodiment of the present invention. The image 200b is composed of characters 202b and attributes 204b, and “command prompt:” is listed within the characters 202b. Any of the commands, such as command “ls”, is keyed in following the command prompt and file folder “Desktop/” is displayed on the image 200b. Thus, the first terminal 102a is allowed to operate the first computing device 104a for the displayed content by inputting command to the next command prompt. During the above operation, the characters 202b and the attributes 204b of the image 200b are saved in the first buffer 106a and in the second buffer 106b, respectively, or saved in single buffer, if the terminal 102a is switched from the first computing device 104a to the second computing device 104b, or if the second switch 110 shown in the FIG. 1B selects one of the first buffer set 116 and the second buffer set 118. That is, the characters 202b and the attributes 204b generated by the commands and operation result of the commands are totally recorded in the first buffer 106a and the second buffer 106b, respectively, or in single buffer.

Please refer to FIG. 1A, FIG. 1B and FIG. 2C which depicts the first terminal 102a showing the image 200c including characters 202c and attributes 204c while the first terminal 102a switches from the first computing device 104a to the second computing device 104b to login to the second computing device 104b via the management system 100a, 100b shown in FIGS. 1A and 1B according to one embodiment of the present invention. Meanwhile, the first terminal 102a switches from the first computing device 104a to the second computing device 104b. Similar to FIG. 2A, the image 200c is composed of characters 202c, attributes 204c from the second computing device 104b, and “login:” input prompt and “password:” input prompt are listed within the characters 202c. “Name2” and “xxxx” are then keyed in following the login prompt and password prompt, respectively, and the first terminal 102a can access the second computing device 104b based on the authorization right. During the above operation, the characters 202c and the attributes 204c are saved in the first buffer 106a and the attributes 204a are stored in the second buffer 106b since the terminal 102a is switched from the first computing device 104a to the second computing device 104b. Alternatively, the characters 202c and attributes 204c are saved in the third buffer 118a and the fourth buffer 118b of the second buffer set 118 if the terminal 102a selects one of the first buffer set 116 and the second buffer set 118 via the second switch 110 shown in the FIG. 1B.

Please refer to FIG. 1A, FIG. 1B and FIG. 2D which depicts the image 202d having input command based on the image 200b shown in FIG. 2B after the first terminal 102a switches from the second computing device 104b back to the first computing device 104a according to one embodiment of the present invention. The image 200d is composed of characters 202d and attributes 204d, and command prompt is listed within the characters 202d. Basically, after the first terminal 102a switches from the second computing device 104b back to the first computing device 104a, the image 202d is re-displayed on the first terminal 102a wherein the image 202d is the same as the image 202b. Because the characters 202b and the attributes 204b of the image 200b are saved in advance in the first buffer 106a and the second buffer 106b, respectively and the characters 202b and the attributes 204b can be accessed again, the image 202d is thus identical to the image 202b.

According to the above-mentioned description and FIGS. 1A-1B, 2A-2D, the management system 100 performs the recording and re-displaying functions while switching the first computing device 102a and the second computing device 102b therebetween. The user operates the first terminal 102a, and the first terminal 102a switches between the first computing device 104a and the second device 104b so that the operated terminal can access the switched computing device. When the operated terminal, i.e. the first terminal 102a, switches from the second computing device 104b back to the first computing device 104a, i.e. from a currently connected port 114b to a previously connected port 114a, the operated terminal is capable of obtaining entire operation image 200d without image loss by recording all the characters and related attributes in the buffer 106. Then, the operated terminal re-displays the image 200b such that the user can continuously operate the first computing device 104a based on the image 200d transmitted from the first computing device 104a. In other words, the image shown on the terminal is changed from the image 200c to the image 200d to allow the user continuously to operate the switched computing device based on the imaged 200d shown on the terminal when the computing devices are switched.

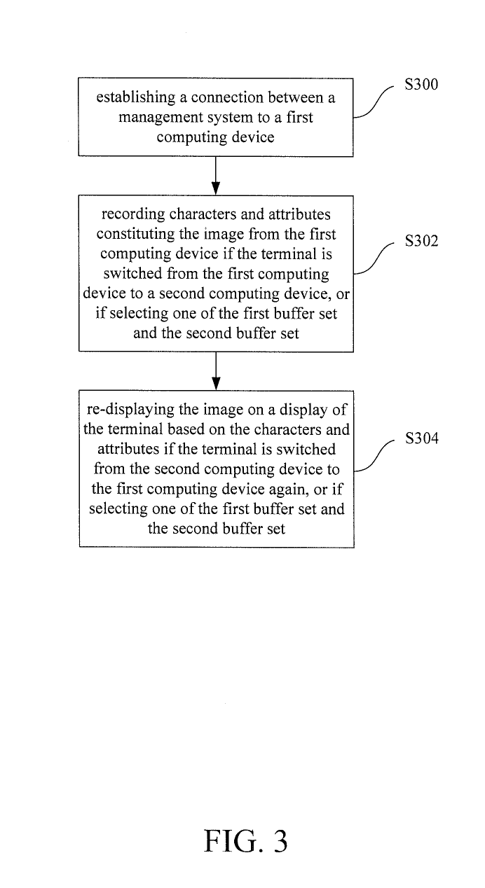

Please refer to FIG. 1A, FIG. 1B and FIG. 3 which shows a flow chart of performing the management system 100 shown in FIG. 1 according to one embodiment of the present invention. It assumes that the first terminal 102a is coupled to the first computing device 104a. The flow chart includes the steps as follows:

In step S300, the management system 100 is coupled to one of the first computing device 104a and the second computing device 104b. In one embodiment, when the management system 100 is coupled to the first computing device104a, the first terminal 102a establishes a telnet connection to login to the first computing device 104a via the management system 100 as if the first terminal 102a is directly connected to the first computing device 104a. Similarly, when the management system 100 is coupled to the second computing device104b, the first terminal 102a establishes a telnet connection to login to the second computing device 104b via the management system 100 as if the first terminal 102a is directly connected to the second computing device 104b.

In step S302, the control unit 112 controls the first buffer 106a and the second buffer 106b for recording a plurality of characters and a plurality of attributes constituting the image from the first computing device 104a if the first terminal 102a is switched from the first computing device 104a to the second computing device 104b, or if the second switch 110 shown in the FIG. 1B selects one of the first buffer set 116 and the second buffer set 118. In one embodiment, the characters and attributes are recorded in the first buffer 106a and the second buffer 106b, respectively. Alternatively, the characters and attributes can be recorded in single buffer.

In step S304, the control unit 112 controls the first buffer 106a and the second buffer 106b for re-displaying the image on a display of the first terminal 102a based on the characters and the attributes if the first terminal 102a is switched from the second computing device 104b to the first computing device 104a again, or if the second switch 110 shown in the FIG. 1B selects one of the first buffer set 116 and the second buffer set 118. Further, the control unit 112 is capable of watching the characters and the attributes constituting the image from the first computing device 104a and the second computing device 104b.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A management system, capable of coupling a terminal to one of a first computing device and a second computing device, the management system comprising:
a first buffer, storing a plurality of characters constituting an image shown on a display of the terminal if the terminal is switched from the first computing device to the second computing device;
a second buffer, storing a plurality of attributes constituting the image shown on the display of the terminal if the terminal is switched from the first computing device to the second computing device; and
a first switch, coupling one of the first computing device and the second computing device to the first buffer and the second buffer.

2. The management system of claim 1, further comprising a control unit coupled to the first switch, controlling the switching procedure between the first computing device and the second computing device.

3. The management system of claim 1, further comprising a second switch, coupling the first buffer and the second buffer to the terminal.

4. The management system of claim 1, wherein the terminal establishes a telnet connection to login to the first computing device and the second computing device via the management system as if the terminal is directly connected to the first computing device and the second computing device.

5. The management system of claim 1, wherein the attributes are selected from one group consisting of background color, foreground color, highlight, underline, blink, inverse video, single-width-single-height, double-width-double-height (top half), double-width-double-height (bottom half), and double-width-single-height and the combinations.

6. A management system, capable of coupling a terminal to a first computing device and a second computing device, the management system comprising:
a first buffer set having a first buffer and a second buffer, storing a plurality of characters and a plurality of attributes which are transmitted by the first computing device and constitute an image shown on a display of the terminal, wherein the characters and the attributes are saved in the first buffer and the second buffer, respectively;
a second buffer set having a third buffer and a fourth buffer, storing a plurality of characters and a plurality of attributes which are transmitted by the second computing device and constitute the image shown on the display of the terminal, wherein the characters and the attributes are saved in the third buffer and the fourth buffer, respectively; and
a switch, coupling one of the first buffer set and the second buffer set to the terminal.

7. The management system of claim 6, further comprising a control unit coupled to the switch, controlling the switching procedure between the first buffer set and the second buffer set.

8. The management system of claim 6, wherein the terminal establishes a telnet connection to login to the first computing device and the second computing device via the management system as if the terminal is directly connected to the first computing device and the second computing device.

9. The management system of claim 6, wherein the attributes are selected from one group consisting of background color, foreground color, highlight, underline, blink, inverse video, single-width-single-height, double-width-double-height (top half), double-width-double-height (bottom half), and double-width-single-height and the combinations.

10. A management system comprising:
a plurality of computing devices having at least one first computing device and at least one second computing device to allow the management system to couple a terminal to one of the first computing device and the second computing device;
a first buffer, storing a plurality of characters constituting an image shown on a display of the terminal if the terminal is switched from the first computing device to the second computing device;
a second buffer, storing a plurality of attributes constituting the image shown on the display of the terminal if the terminal is switched from the first computing device to the second computing device; and
a switch, coupling one of the first computing device and the second computing device to the first buffer and the second buffer.

11. The management system of claim 10, further comprising a control unit coupled to the switch, controlling the switching procedure between the first computing device and the second computing device.

12. The management system of claim 10, wherein the terminal establishes a telnet connection to login to the first computing device and the second computing device via the management system as if the terminal is directly connected to the first computing device and the second computing device.

13. The management system of claim 10, wherein the attributes are selected from one group consisting of background color, foreground color, highlight, underline, blink, inverse video, single-width-single-height, double-width-double-height (top half), double-width-double-height (bottom half), and double-width-single-height and the combinations.

14. A method for a management system to re-display an image on a terminal wherein the management system couples the terminal to one of a first computing device and a second computing device, the method comprising the steps of:
establishing a connection between the management system to the first computing device;
recording a plurality of characters and a plurality of attributes constituting the image from the first computing device if the terminal is switched from the first computing device to the second computing device; and
re-displaying the image on a display of the terminal based on the characters and the attributes if the terminal is switched from the second computing device to the first computing device again.

15. The method of claim 14, wherein the characters and attributes are recorded in a first buffer and a second buffer, respectively.

16. The method of claim 14, wherein the characters and attributes are recorded in a buffer.

17. The method of claim 14, during the step of establishing the connection between the management system to the first computing device, further comprising a step of establishing a telnet connection to login to the first computing device via the management system as if the terminal is directly connected to the first computing device and the second computing device.

18. The method of claim 14, wherein the attributes are selected from one group consisting of background color, foreground color, highlight, underline, blink, inverse video, single-width-single-height, double-width-double-height (top half), double-width-double-height (bottom half), and double-width-single-height and the combinations.
